(19) United States
(12) Patent Application Publication
(10) Pub. No.: US 2005/0075909 A1
(43) Pub. Date: Apr. 7, 2005

(54) Medical record cards and storage systems

(76) Inventor: Geoffrey Flagstad, Barrington, IL (US)

Correspondence Address: MCANDREWS HELD & MALLOY, LTD, 500 WEST MADISON STREET, SUITE 3400, CHICAGO, IL, 60661, US

(21) Appl. No.: 10/679,749

(22) Filed: Oct. 6, 2003

(51) Int. Cl. G06F 17/60

(52) U.S. Cl. 705/3

(57) ABSTRACT

A method and apparatus for obtaining and storing medical records of a patient from an entity covered by HIPAA in a form allowing quick disclosure of the patient's medical history to a third party without restriction or delay by HIPAA. The method comprises inducing a patient to obtain possession of his or her own medical record from a covered entity; acquiring the medical record from the patient in a storage format; and storing the medical record in a memory in a form from which it can be reproduced in the storage format as received from the patient. The memory used to store the medical record can be a hard drive in an Internet server, or be a portable medium, such as a CD or DVD, and can be small enough to fit in the patient's wallet, purse or pocket. The apparatus is a medical storage system that can be used to carry out the method, which comprises a communication interface linked to the Internet and a data storage device.

### BACKGROUND OF THE INVENTION

The present invention relates generally to a method and apparatus for obtaining and storing medical records of a patient from an entity covered by the Health Insurance Portability and Accountability Act of 1996 (“HIPAA”) in a form allowing quick disclosure of the patient's medical history to a third party without restriction or delay by HIPAA.

When providing health care, a physician interviews the patient to obtain a medical history, examines the patient, and conducts or orders physical and laboratory studies. The treatment prescribed by the physician will be determined from the interview and the results of examination and tests. These tests can be costly. With a proper medical history some tests may not be necessary. A physician's full and accurate knowledge of a patient's medical history including information such as current medications, drug allergies, past medical test results, etc. will permit the physician to diagnose the patient more accurately, more quickly and more efficiently.

In the current medical world, however, a patient in most cases never sees his or her own medical records. The patient may not remember accurately all the details of his or her treatments, nor be able to obtain records from their source. Old records are lost, particularly when hospitals merge, physicians retire, new physicians are consulted, time passes, or the recordkeeping system changes (as when changing from paper records to electronic records, at which time the information on the paper records may not be transferred). Current records are difficult to obtain. And it takes time for the patient to recall where relevant medical records are kept, to retrieve them, and for medical personnel to look through them for relevant information.

In an emergency, for example if the patient has suffered trauma or is unconscious, the patient may be unable to provide a medical history when it is urgently needed. Emergency medical care is the most expensive component of most corporate healthcare benefit programs. Statistics show that forty percent of all hospital admissions start with an emergency room admission and usually result in long term care. There are 110 million plus emergency room visits each year in the United States. There are over 60 million hospital admissions in either federally regulated hospitals or community hospitals. Medical expenses are approximately 14% of the Gross National Product (GNP) of the United States. On average, proper medical histories if available on demand in clinics or hospitals for patient care would reduce medical testing and save $250 to $500 per hospital visit. For example, with a patient's complete medical history, anomalies that are normal to the patient but abnormal on diagnosis would not require duplication of tests. Elimination of unnecessary testing would also reduce emergency admissions.

For these and other reasons, health care providers have invested considerable effort in the technologies related to the computerization, storing and sharing, typically by fax or computer communications networks, of patients' medical records and information. A medical release titled “Emergency Department Technology” and dated Mar. 17, 2002, a publication of the American College of Emergency Physicians (“ACEP”) discusses standards for the future of technology in emergency medicine. The first objective standard stated in the release is: “All medical personnel involved in caring for a patient will be working from the same electronic record.”

However, electronic transmission of a patient's medical information is subject to a series of federal laws and regulations, such as HIPAA. Under HIPAA, generally, physicians, hospitals, health care clearinghouses (“HCCs”), or other health care entities cannot release medical information or records about an individual to third parties without written permission by that individual. As required by HIPAA of 1996, the U.S. Department of Health and Human Services (“HHS”) issued Standards for Privacy of Individually Identifiable Health Information (“Privacy Rule”) very recently. See HIPAA § 264, 42 U.S.C. § 1320d-2 note (2003). The Privacy Rule establishes a set of standards for protecting certain types of health information and applies to “covered entities” and “business associates” of a covered entity, as defined in HIPAA and its regulations. It restricts the use and disclosure of “individually identifiable health information” that is transmitted or maintained, in any medium, by a covered entity or its business associates.

The Privacy Rule was intended to protect the individual from reckless dissemination of personal medical information. It mandates certain behavior and procedures that must be followed strictly when handling, transferring, and processing a patient's medical information. As a result, all medical providers and staff must demonstrate HIPAA compliance or face severe sanctions including loss of reimbursement, loss of billing privileges, and even severe fines.

HIPAA has caused many impediments to communication between healthcare providers and the transfer of medical information, particularly between separate medical entities. Fears of litigation have caused the medical community to test for a wide series of disease states, instead of finding out what testing has been done elsewhere. There is also reluctance to share medical information lest one run afoul of these potentially-costly policies. Even those willing to share medical information may not be able to do so quickly, or outside of normal business hours, or may be reluctant to undergo the effort to determine and document that the records may properly be transferred to the requester. Therefore, there is a need among the medical community for a way to acquire medical records of a patient from a covered entity, store them in a form meeting the ACEP standards, and quickly disclose the medical information to a third party without restriction by HIPAA.

This need is not addressed and solved by prior medical information storage and retrieval systems. Rosen, et. al. (U.S. Pat. No. 6,073,106, the “Rosen patent”) relates to methods of managing personal or medical information and of controlling access to it by Internet communications or by phone/fax/mail, and more particularly to those methods in which a security measure may be overruled and access to a portion of the personal information may be disclosed under specified circumstances. However, the Rosen patent does not disclose how to acquire, transmit and store the medical record to avoid the information service provider from being a “covered entity” (or a “business associate” of a “covered entity”) under HIPAA. Even more so, some other medical data storage and retrieval information systems, such as those of U.S. Pat. Nos. 5,455,082, 5,327,341 and 4,315,309 which are discussed in the Rosen patent, have been directed to the needs of the health care provider or health plan, and developed without HIPAA in mind. These systems are likely to be covered by the Privacy Rule.

Known techniques to provide medical information to a physician include emergency medical bracelets, printed information cards, “smart cards,” and other products. These techniques all have important drawbacks. For example, only a limited amount of information can be stored as printed text on a medical information bracelet or card, even if the information is reduced to microfilm (in which case it cannot be read without a special reader). A magnetic strip or a “smart card” can store more information, but the health care provider must have access to a specially-designed smart card reader. This requires the entire medical establishment to invest in a particular technology. Furthermore, a person's medical file is a constantly-changing and fluid record in which important information may (and will) change overnight. Acting upon outdated information can be disastrous. However, an individual cannot quickly update his or her medical information stored on a smart card by him- or herself.

Berman (U.S. Pat. No. 6,523,116 B1) relates generally to a method and apparatus for personal information data storage and retrieval. More specifically, the Berman patent is directed to the use of a public key provided on one's business cards for use with a database operated by targeted recipients of such cards. The person's public key is published on business cards in legible or machine readable format. Even though this database system could store medical information of a person, the database system is developed with the targeted recipients of such business cards in mind and is not patient oriented. To use the system, a targeted recipient must have subscribed to the system and have had its own public key and private key. The Berman patent also does not explain how to put medical information on the system without requiring HIPAA compliance to give targeted receipts of the business cards Internet access to a database in the system. Furthermore, the Berman system requires the user to distribute the business cards recorded with his or her public key to the targeted recipients, so a recipient can use its own private key and the person's public key to get access to the person's information.

There are other medical data storage and retrieval information systems that offer online medical record services. Some of them, such as www.medicalogic.com, are designed primarily for use by healthcare organizations and providers and are updated as a physician enters new information on a patient's record. These services are subject to HIPAA regulations. Another requirement for these services is that the user must be part of a medical system that employs this service. This poses a concern for those in need of their medical records when traveling or living in an area not currently using the system. Other medical record storage sites, such as www.medrecordsweb.com and www.vitallink-canada.com, require that the data either be entered by the subscribers' physicians or transferred from medical facilities to be input by the web site's staff. These transfers of personal medical information are subject to HIPAA regulations and will impose a great deal of extra paperwork and potential liability to those handling, processing, and entering the information. There will be a time delay in the data entry also, during which time medical conditions may develop or change. If there are errors in the information provided or data entry then these, too, will require time to change.

There is a strong need in the medical community for a medical record that can be update, easily and instantly, which is exempt from HIPAA regulations, and from which important and relevant information of the patient can be accessed and conveyed quickly.

### BRIEF SUMMARY OF THE INVENTION

The present invention provides a method to obtain a medical record of a patient from a HIPAA “covered entity,” for example a physician, hospital, or insurance company. The record is obtained in a form allowing it to be disclosed to a third party without restriction by HIPAA. The method includes several steps.

In one aspect, the person(s) or entity(ies) carrying out this method induces a patient to obtain possession of his or her own medical record from a covered entity. (Such person(s) or entity(ies) are referred to in this disclosure as the “service provider,” where the service provided is one or more steps of the present invention.) This may be induced, for example, by providing the patient with instructions or a request form enabling the patient to obtain a medical record. In one embodiment, such instructions or request forms are provided on the service provider's website. In another embodiment, the service provider carries out this method through software offered by the service provider and installed in the patient's personal computer. In the latter embodiment, the instructions or request forms are provided in or with the system software. This step relies on the provisions of HIPAA that an individual is permitted to review and obtain copies of his or her own medical records from any covered entity.

The service provider then acquires the medical record from the patient in a storage format. (“Storage format” identifies the form of the record when it is acquired from the patient by the service provider.) The storage format of the medical record may be the same as or different from the format of the medical record maintained by a covered entity or originally received by the patient. For one example, the service provider can acquire the record from the patient in the same format in which the covered entity provided the record to the patient. As another example, the patient can provide to the service provider a record that has been summarized, abstracted, retyped, redacted, supplemented, converted from paper to electronic form or vice versa, or otherwise modified from its original form.

This acquisition step relies on the provisions of HIPAA that an individual is permitted to change the information in his or her own records, and can give the information in whole or in part to anyone else, without restriction on the patient or the recipient, even if the information is copied or derived from a confidential medical record of the patient. Neither the patient nor the recipient becomes a “covered entity,” “business associate” of a covered entity, or is otherwise restrained from further disclosing or making use of the information as the result of receiving a patient's medical record from the patient.

Optionally, the service provider may induce the patient to obtain possession of the medical record in a first format and also induce the patient to convert the medical record to a storage format different from the first format.

Optionally, instead of or before acquiring the medical record from the patient, the service provider may induce the patient to input the medical record in the storage format to a personal computer using software offered by the service provider and installed in the personal computer. In this step, the personal computer “acquires” the medical record.

The service provider then stores or induces the patient to store the medical record in a memory. The medical record is stored in a form from which it can be reproduced in the storage format as received from the patient. For example, if the service provider acquires the medical record from the patient as a paper record, the record can be stored in electronic form (as by scanning it into an Adobe Acrobat® PDF® file), from which it can be reproduced in the original format (a paper copy), either directly or by transmitting the PDF® file to a third party who can then print the file. The present invention does not require the record to be reproduced in the original format; the record must, however, be reproducible in the original format. The intention here is to avoid the need for the service provider to modify the information or its format in a way that could be interpreted as “data processing,” as discussed in HIPAA.

Optionally, the service provider may obtain from the patient an agreement to allow the service provider to transmit all or part of the medical record to a health care provider under defined conditions. This agreement can be entered into before one of the defined conditions arises. For example, the patient and service provider can agree when the patient is well that the service provider will give emergency room employees access to the patient's drug allergy information, without obtaining the patient's agreement at the time access is given, if the patient is taken to the emergency room unconscious, or is otherwise unable to provide his or her own drug allergy information to the emergency room employee. Such an agreement would allow immediate transfer of important drug allergy information to the emergency room employee, even if the patient were unconscious or otherwise physically or mentally unable to provide the information or approve of its transfer at the time he or she entered the emergency room.

Optionally, the memory used to store the medical record can be a portable medium, such as a CD or DVD, another optical disk format, a “smart card,” or the like, and can be small enough to fit in the patient's wallet, purse or pocket. Optionally, the memory can be linked to a computer communications network (for example, the Internet) as part of a storage server and the medical record can be remotely retrieved from the memory through the Internet.

Optionally, the medical record can be stored in a hierarchical storage system. Optionally, in this hierarchical storage system the medical record is assigned to at least one electronic file folder. The electronic file folder may contain sub-folders. All medical records assigned to a file folder or sub-folder can share one or more common attributes. For example, they all may be electrocardiogram (“EKG”) records of the patient. Optionally, a file folder can be assigned to at least one file template in which all the file folders share one or more common attributes. For example, all the folders containing cardiology records of the patent, including electrocardiograms, cardiologist examination records, angioplasty records, etc., may be assigned to one file template. Optionally, all the file templates can be stored together in the hierarchy of the storage system to form a general medical and personal information file of the patient.

This hierarchical storage system can also be used to provide hierarchical storage access, i.e. access to a special file template (for example, an emergency file template or archival file template) can be on a different basis than the basis for access to the general medical and personal information file and/or other file templates. For example, an emergency medical technician may have access to files in a template providing drug allergies and prior heart attack history, but not to records in another template regarding treatment for venereal diseases that was completed a long time ago.

In a further aspect, the invention provides a medical storage system for obtaining and storing a medical record of a patient from a covered entity of HIPAA in a form allowing quick disclosure of the medical record to a third party without restriction by HIPAA. The system includes a communication interface and a data storage device. The communication interface can be used for inducing a patient to obtain possession of a medical record of the patient from a covered entity, and optionally for acquiring the medical record from the patient in a storage format. The data storage device can include a memory for storing the medical record in a form from which it can be reproduced in the storage format.

The communication interface of the system may be adapted to induce a patient to obtain possession of a medical record in a first format and then convert the medical record to a storage format different from the first format. The communication interface can further obtain the agreement of the patient to allow transmission of the stored medical record to a health care provider under defined conditions before a defined condition arises.

The data storage medium, i.e. the memory, used by the system may be a portable medium such as a CD or DVD, and preferably the portable medium is small enough to fit in a wallet, purse or pocket. The memory may also be a hard drive. In another embodiment, the data storage medium can be linked to the Internet, so the medical record stored in the memory can be retrieved remotely through the Internet.

Optionally but preferably, the data storage uses a hierarchical storage system as previously described.

In a further aspect, the medical information system of the invention can further be used to obtain and store other information or documents of a patient, such as a living will, investment portfolios, life insurance and credit arrangements, etc. These can be stored in the hierarchical system in a way limiting access, so the patient can carry and manage non-medical private information on the same medium as emergency medical information without necessarily giving medical personnel access to the non-medical information.

### BRIEF DESCRIPTION OF SEVERAL VIEWS OF THE DRAWINGS

FIG. 1 shows the system components of the invention and the information flow among the system components according to an embodiment of the present invention.

FIGS. 2 and 3 show a hierarchical storage system according to an embodiment of the present invention.

### DETAILED DESCRIPTION OF THE INVENTION

As used herein, “patient” means the subject of the information in question, and a “patient” does not need to be a person currently receiving or seeking medical care. A “service provider” is a person or entity carrying out or assisting a patient or a third party to carry out the present invention, where the service provided is one or more steps of the invention, or a software or hardware system that the patient or a third party can use to carry out one or more steps of the invention.

The present invention is unique in that it emphasizes immediacy of information retrieval by a patient or the patient's representatives and it emphasizes the absolute patient control of the information recording process. The present invention involves constructing a file system from the ground up (the patient) as opposed to a top down (physicians, hospitals, pharmacies, or other health care providers) approach. These unique characteristics of the present invention will exempt an Internet medical storage system based on the present invention from HIPAA, because such a system is neither a covered entity nor a business associate of a covered entity as defined by HIPAA and other regulations.

A covered entity is a “health plan,” “health care clearinghouse,” or “health care provider who transmits any health information in electronic form in connection with a transaction.” 45 C.F.R. § 160.103; see 42 U.S.C. § 1320d-1(a). A health plan is “an individual or group plan that provides, or pays the cost of, medical care.” 45 C.F.R. § 160.103; see also 42 U.S.C. § 1320d(5) (defining “health plan”). A health care clearinghouse (“HCC”) is a “public or private entity” that either “[p]rocesses or facilitates the processing of health information received from another entity in a nonstandard format or containing nonstandard data content into standard data elements or a standard transaction” or “[r]eceives a standard transaction from another entity and processes or facilitates the processing of health information into nonstandard format or nonstandard data content for the receiving entity.” 45 C.F.R. § 160.103; see also 42 U.S.C. § 1320d(2) (defining “health care clearinghouse”). A health care provider is a “provider of medical or health services,” including any “person or organization [that] furnishes, bills or is paid for health care in the normal course of business.” 45 C.F.R. § 160.103; see also 42 U.S.C. § 1320d(3) (defining “health care provider”). To be a business associate, the person performing the function or activity must be either doing so “on behalf of” a covered entity or providing a service “for” the covered entity that has provided the person with protected information. 45 C.F.R. § 160.103; see Standards, 65 Fed. Reg. at 82476.

A medical file storage system is not necessarily a health plan nor a health provider. It might however, be a health care clearinghouse (“HCC”) if it processes or facilitates the processing of health information received from another covered entity as defined by HIPAA and the regulations. Although neither the statute nor the regulations more precisely define “processing,” the use of the term in the statute, regulations, and the Privacy Rule indicates that unless an entity performs the processing function for another entity, it is not an HCC; entities that provide mechanisms to convey information (for example, Internet Service Providers and telephone companies) are not HCCs unless they perform the requisite processing function; and processing encompasses translation or conversion of medical records to or from a standard data format. In other words, to be an HCC, an entity must translate or facilitate the translation of incoming health information from a nonstandard format into a standard format for the covered entity it receives the data from, or it must translate or facilitate the translation of standard health information into a nonstandard format for the covered entity the data is being sent to. This interpretation is reinforced by the ordinary meaning of “process,” which is “a series of actions, changes, or functions bringing about a result.” The American Heritage Dictionary of the English Language (4th ed. 2000).

Furthermore, in general, an individual has a “right of access” to obtain a copy of protected health information regarding that individual. 45 C.F.R. § 164.524(a). A covered entity is both permitted and required to disclose protected health information to an individual or as provided by an authorization from the individual. 45 C.F.R. § 164.502(a)(1)(i), (iv). The regulations specifically point out that information disclosed with proper authorization can be re-disclosed by the recipient and is no longer restricted.

C.F.R. § 164.508(c)(2)(iii). In addition, in responding to comments on the proposed regulations, HHS has stated that after protected information has left a covered entity (or a business associate of a covered entity), HHS no longer has jurisdiction to protect the information. See Standards for Privacy of Individually Identifiable Health Information, 65 Fed. Reg. 82462, 82567 and 82631 (Dec. 28, 2000).

In accordance with an embodiment of the invention, the medical information of a patient stored in a medical file storage system is provided by the patient, and is stored as the patient provides without any change or alteration to its content or format. In other words, a medical file storage system based on the present invention copies, stores, retrieves, and delivers medical information in the storage format as received from the patient, who obtained his or her own medical information from a covered entity. Such a medical file storage system is not a HCC because it does not process or faciliate the processing of health information received from a covered entity; it only receives and stores medical information of a patient that is provided by the patient himself or herself; and the patient still owns and has full control of the information stored in such a system. A medical file storage system based on the present invention is not a business associate of a covered entity because it neither acts “on behalf of” a covered entity nor provides a service “for” the covered entity that has provided the Internet medical storage system with protected information.

In one embodiment of the present invention, the present method is conducted by an Internet medical storage service provider. Communications between the patient, the service provider and a third party medical information requester (hereinafter “the third party”) can be conducted by various means including online interactive communications between the patient's or the third party's computer and the service provider's Internet server and website (for example www.medlifecard.com; or www.mlcnet.net) by the Internet.

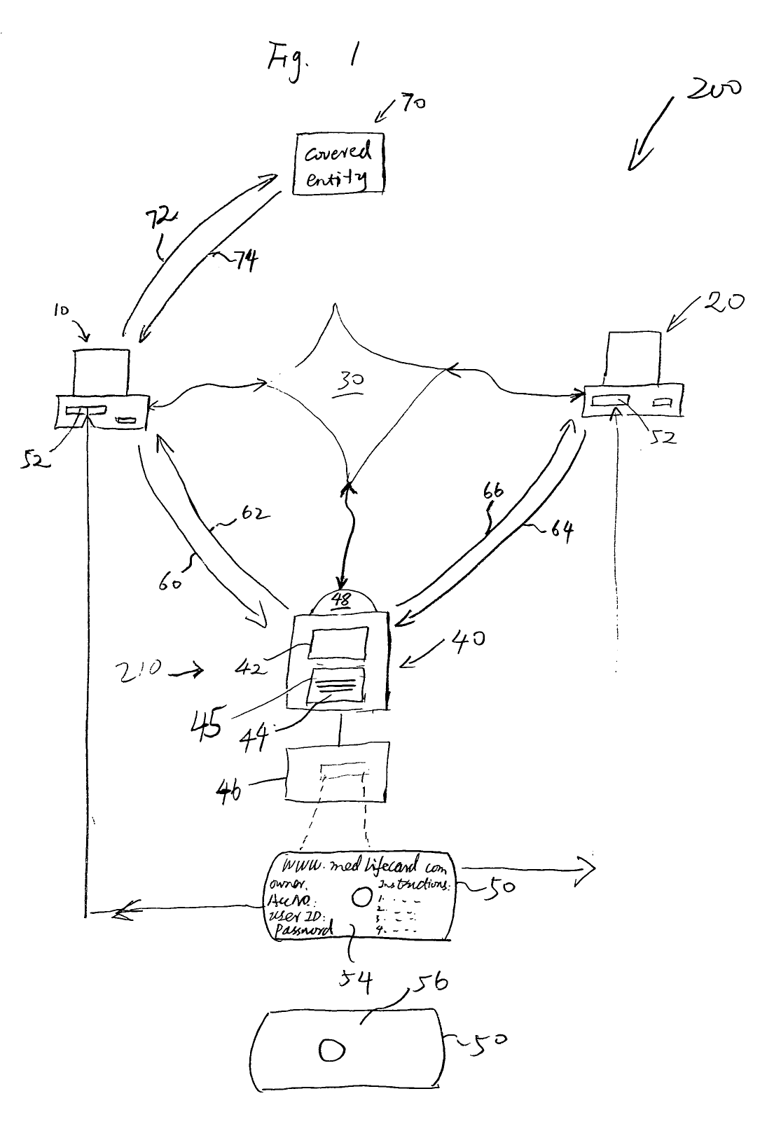

Referring to FIG. 1, in accordance with an embodiment of the present invention, a first personal computer 10 and a second computer 20 (or laptop or personal digital assistant, for example) include hardware and software (not shown) for connection to the Internet 30 or another computer communications network, which optionally may be publicly accessible. For example, the computers 10 and 20 may connect to the Internet 30 by modems, or may be nodes in a local area network (“LAN”) that has access to the Internet 30. The computer 10 is located in a place (for example the patient's home) so that the patient (not shown) can have access to and use it, and the computer 20 is located in a place (for example an emergency room) where a third party (for example an emergency room physician or attendant) can have access to and use it conveniently. The computer 20 might also be another computer the patient can personally use. The Internet server 40 may be located on the premises of an Internet medical storage service provider, and is connected to the Internet 30 to provide medical data storage services.

Referring still to FIG. 1, in one embodiment the Internet server 40 includes at least one data processor 42, a data storage medium 44 (for example the magnetic disks of a hard drive) of a data storage device 45 (for example the complete hard drive assembly), and optionally another data storage device 46, which may be a CD burner or other device which stores data on a CD 50 or other portable memory. Whatever internal configuation the Internet server 40 has, there is at least one communication link to the Internet 30 which permits access by authorized persons, such as medical personnel authorized by the patient or having access to the CD 50. The Internet server 40 provides access to its databases by interactive communications made over the Internet 30 on the website 48 of the Internet server 40.

The CD 50 or other portable memory in accordance with one embodiment of the present invention optionally can be specially shaped to fit in a wallet, or purse or pocket (not shown), and if adapted for wallet storage it can be slightly wider than a conventional wallet card, with indicia near its top, so it will project from a wallet pocket to display the indicia. The displayed indicia can indicate that the CD is a medical record so a medical person treating the patient when the patient is unconscious can readily find and use the information on the CD. The computer 10 or the Internet server 40 can be used to burn in part or all of the patient's medical file on the CD 50, which can be read by the CD-ROM drives 52 of the computers 10 and 20. The CD 50, as a memory, is also part of the data storage device 45 in this embodiment. As will be evident to those skilled in the art, the apparatus used to convert medical records to electronic form, produce the CD 50, and communicate by the Internet 30 need not be the same apparatus, or be in the same vicinity, or be operated by the same person or entity, providing the respective functions of any required apparatus are carried out in some manner.

In accordance with an embodiment of the invention, before the patient requires access to medical information, the patient is induced to register and open an account with the service provider to establish log-on information such as an account number, a user I.D., or a password, which the patient can use to log on to the service provider's Internet server 40 through its website 48. An account can be established, for example, by Internet communications or by phone/fax/mail communications. With the account log-on information, the patient can then log onto his or her account with the Internet server 40 using the computer 10, and once in his or her account, the patient can change his or her log-on information as he or she wants.

Referring still to FIG. 1, the transactions or online interactive communications between the patient and the service provider needed to carry out the present method are represented by the data flows 60 and 62 (which may either be via the Internet 30 or independent of the Internet, as by mailing records). The series of transactions or online interactive communications needed between the service provider and the third party medical information requester to carry out the present method are represented by the data flows 64 and 66 (which may either be via the Internet 30 or independent of the Internet, as by a patient carrying a CD 50 or other data storage medium made by, or with data sent from, the service provider and bringing the CD to an operator of the third-party computer 20); and the series of transactions or communications between the patient and a covered entity 70 (for example a hospital treated the patient before) who provides the medical record to the patient are represented by the data flow 72 and 74 (which may either be via the Internet 30 or independent of the Internet, as by mailing records). While transactions or communications by computers by the Internet 30 are preferred in some instances, transactions or communications by fax/phone/mail or other physical or electronic forms of delivery are also contemplated.

The Internet server 40 can be used to induce the patient to obtain his or her medical record from the covered entity 70. If the medical record is not in an storage format, the Internet server 40 can be used to induce the patient to convert the medical record to a storage format. Such a storage format may be a format that meets the ACEP standards. As an example, the patient may be induced to summarize, abstract, retype, redact, supplement, convert from paper to electronic form or vice versa, or otherwise modify from its original form a medical record obtained. The patient can easily convert the medical record using simple templates provided by the Internet server 40 directly on the website 48, or using templates that are downloaded to the computer 10 from the Internet server 40 or installed in the computer 10 with software offered by the service provider.

The medical record that the patient is induced to obtain may contain information such as immunizations received, physical examination results, past illnesses, personal histories, allergies, prescription drug usage, surgical and hospitalization history, medical histories of parents, grandparents, or siblings, laboratory or clinical test results, contact information for the medical personnel who have treated the patient, and so on. It may also include important documents or electronic records such as recent EKGs, magnetic resonance imaging studies (MRIs), X-rays, etc.

According to an embodiment, the Internet server 40, by its data processor 42, acquires the medical record in a storage format and then stores it in the storage medium 44 in a form from which it can be reproduced in the storage format. The medical record can be uploaded to the Internet server 40 directly by the Internet 30 as an electronic document. However, if a medical record is a paper document that needs to be scanned or otherwise copied to produce an electronic document, and the patient cannot prepare the electronic document, it can be mailed or faxed to the service provider or a third party, who can scan it into the Internet server 40 without changing its format or contents.

Optionally at least the most pertinent part of the medical record for emergency treatment is also stored on the CD 50. Referring to FIG. 1, in accordance with an embodiment of the present invention, basic information of the service provider (for example its name and website), of the patient (for example his or her name, account number, user ID, or password for emergency access to medical records), and instructions for use can be printed on a label 54 attached to the CD 50, and the patient's medical file can be burned onto one or more surfaces such as 56 of the CD 50.

If the patient's medical file is stored in both the storage medium 44 of the Internet server 40 and the CD 50, which are both memories: the CD 50 is a back-up to the Internet server 40 and the Internet server 40 is a back-up to the CD 50. The CD 50 may be produced in multiple copies for multiple uses, and the patient can carry a copy of the CD 50 in his or her wallet, purse or pocket, on a lanyard, give them to relatives or neighbors, keep them in an automobile, or otherwise make them available in an emergency.

However, Internet server 40 does not need to be involved in carrying out the present invention. In an alternate embodiment, for example, the service provider can offer a home software package for a patient or the patient's family. The home software package includes the system software for a home health file storage system and, optionally, a number of CDs 50 or other portable media. The home health file storage system can optionally be Internet interactive with the Internet medical storage system described above, but it can also be independent. Following instructions provided by the service provider, the patient installs the system software into the computer 10. The service provider can then induce the patient, through the system software and/or other instructions provided with the system software, to obtain his or her medical record from the covered entity 70, to input the medical record in a storage format into the computer 10, and to store it in a storage medium, such as the hard disk (not shown) of computer 10, CD 50 or other storage media (e.g., a smart card), in a form from which it can be reproduced in the storage format. In order to store the medical record in CD 50, a CD-burner is required, which can be the same device as the CD-ROM drive 52 if it is both a CD reader and rewriter.

Even though the CD 50 is specially shaped and is smaller than a regular CD, it can be universally used in most computers'CD or DVD readers, such as the CD-ROM drives 52 of the computers 10 and 20. The patient, his or her assignee or a third party authorized by him (for example a physician seeing the patient) can easily access, retrieve, or reproduce the medical record stored in the CD 50 or the Internet server 40 using the computer 10 or 20 and the information printed or stored on the CD 50.

In an embodiment, the service provider can obtain the agreement of the patient to allow transmission of the medical record to a health care provider, a relative, or another third party under defined conditions. This agreement may be obtained at the time the medical record is needed, but advantageously this agreement can be obtained in advance of treatment at the patient's convenience, before a defined condition arises necessitating immediate access to the record. Such defined conditions may include when the patient is in an emergency or unconscious condition, when the CD 50 is presented to health care provider, etc. By obtaining the agreement in advance, the patient can search for, obtain, and organize the records thoroughly and accurately, select what information to make available, and/or transmit the information in a suitable format to the service provider so it will be available and arranged in good order in an emergency.

For example, when the patient is away from home and is taken to an emergency room while unconscious for emergency care, the unique CD 50 in the patient's wallet, or pocket, or purse, can be designed to be easily seen so it will be found by a health care worker or other person searching for emergency medical information. Referring again to FIG. 1, the emergency attendant (not shown) can either use the CD-ROM drive 52 of the computer 20 to read the patient's medical file stored in the CD 50, or use the log-on information provided on the CD 50 or alternately a printed medical emergency card containing access information (not shown) to log onto the Internet 30 for access to the patient's medical file stored in the Internet server 40 (if it is available). Under this condition, in accordance with one embodiment of the present invention, the entity maintaining the Internet server 40 can be allowed by the agreement to immediately transmit the patient's medical record to the emergency attendant's computer 20 by the Internet 30 so the emergency attendant can quickly understand the patient's medical history or is immediately alerted to special conditions.

The present method may further comprise the step of inducing the patient to update the medical record stored in the memory, i.e. the storage medium. New information is easily updated by the patient by logging onto the Internet server 40 or entering the home health file storage system installed in the computer 10. The patient can update his or her records directly online, or can update the information with the template downloaded to or installed in the computer 10 and then, optionally upload the new information to the Internet server 40 by the Internet 30. A new CD 50 can be quickly issued to the patient, or if the CD 50 is a re-writable CD, the patient him- or herself can re-write the CD 50 with the updated medical file. Also, the present method may further comprise the step of inducing the patient to provide other personal information or documents such as payment authorization information, health insurance provider information, a living will, investment portfolios, life insurance and credit arrangements, etc., and then storing them in the Internet Server 40 and/or on the CD 50.

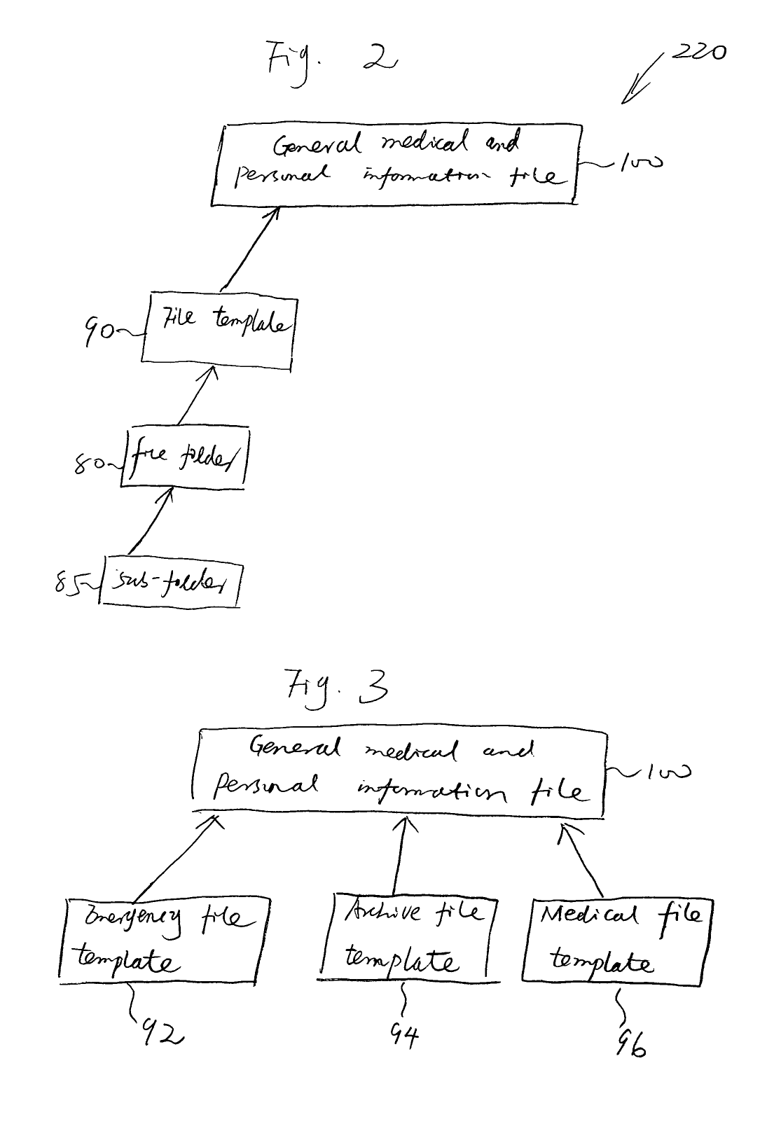

In an embodiment, the present method stores the medical record in a hierarchical storage system that can provide hierarchical access. Referring to FIG. 2, in accordance with an embodiment of the present invention, a medical record (not shown) may be assigned to at least one file folder 80, and all medical records assigned to a file folder can share one or more common attributes. For example, all medical records from a certain physician can be assigned to a file folder, all medical records from a certain hospital can be assigned to another file folder, all medical records relating to various tests and lab results can be assigned to a third file folder, all medical records relating to a specific physical condition or disease can be assigned to a fourth file folder, all medical records relating to a particular organ, such as the liver, can be assigned to a fifth file folder, and so on. The file folder contents may overlap, as when some of the particular physician records in one file folder relate to the particular disease in another file folder. The file folder 80 may comprise a sub-folder 85. For example, the file folder for tests and lab results may include sub-folders for EKGs, MRIs, X-rays, etc. Then the file folder 80 is assigned to at least one file template 90. The file folders assigned to a file template such as 90 can share one or more common attributes. For example, all the file folders containing information that might be useful in an emergency can be assigned to an emergency file template, and all file folders that contain archival information such as a living will, investment portfolios, life insurance and credit arrangements can be assigned to the archive file template. In accordance with an embodiment of the invention, all file templates are stored together in the hierarchy to form a general medical and personal information file 100 of the patient.

In this hierarchical storage system, access to a special file template can optionally be allowed on different terms than access to the general medical and personal information file 100 or another file template. Referring to FIG. 3, an example of a special file template is the emergency file template 92. A special file template (or any template) can be read-only so it cannot be altered by the third party. In accordance with an embodiment of the present invention, the information file 100 further comprises an archive file template 94 and a medical file template 96 that contains more medical information of the patient (for example information relating to venereal diseases long in the past) and is fully functional so its contents can be changed or updated by a person who has access to it.

The hierarchical storage access can be illustrated by a simple example. With the log-on information (account number, user ID and password) printed on the CD 50 or a medical emergency card, an emergency attendant can log on and have access to the emergency file template which is read-only, but to log on and have access to the general medical and personal information file 100 or other file templates such as the archive file template or the medical file template, one needs to answer a secret question in addition to the log-on information. With the hierarchical storage system, in another embodiment, a special file template (such as the emergency file template 92 or archive file template 94) is stored in a separate CD 50, requiring different access information from the CD storing the general medical and personal information file 100.

An alternate embodiment of the present invention, referring to FIG. 1, is an medical and personal information system 200 for obtaining and storing a medical record of a patient from a covered entity in a form allowing quick disclosure of said medical record to a third party without restriction by HIPAA. Referring to FIG. 1, the information system 200 comprises a communication interface 210 which comprises, in accordance with an embodiment of the invention, the Internet server 40 (e.g. a computer), the website 48, and the data processor 42. The Internet server 40 acting through the communication interface 210 is programmed to induce the patient to obtain possession of a medical record of the patient from a covered entity 70. For example, this may be done by placing on the website 48 instructions that a subscribing patient should obtain his or her medical records directly from the covered entities possessing the records. This optionally can be facilitated by providing the subscribing patient with a form letter to be sent to a covered entity to obtain copies of medical records. The form letter can provide information to the sender and recipient respecting how the records should be requested, who must request the records, how the requester can verify that the request is genuine, and so forth.

The website 48 can also be programmed or interlinked to provide additional information that may help the patient to request relevant medical records. For example, the website can provide, or link to, a directory of physicians, hospitals, and other health care providers and their contact information, so the patient can find out how to contact pertinent providers. The website can also be programmed to direct an e-mail request for medical records directly to a medical care provider, and can be programmed to provide the e-mail address of the selected medical care provider automatically, or to alert the patient if a proposed e-mail to a medical care provider does not bear the correct e-mail address of the selected medical care provider.

If the medical record is obtained by the patient in a format different from the intended storage format, the present system can be programmed to induce the patient to convert the medical record to the intended storage format. In an embodiment of the invention, an intended storage format can be a format that meets ACEP standards.

In accordance with an embodiment of the present invention, the Internet server 40 acting through the communication interface 210 can be programmed to further obtain the agreement of the patient to allow transmission of the medical record to a health care provider under defined conditions. This agreement can be obtained before a defined condition arises. The agreement can be obtained by placing on the website 48 a proposed agreement defining the conditions under which third parties will be given access to the information, or certain categories of information, and soliciting a response by the patient, as by clicking on a field displayed by the website 48, indicating assent to the terms of agreement. The service provider can then set up the subscriber's account to carry out the terms of the agreement.

In an embodiment, more than one proposed agreement can be presented on the website, and the patient can be instructed to select which of the agreements the patient wants to use. The agreement can also be provided in modular form, as in a checklist, and the patient can be induced to indicate assent to particular terms the patient finds suitable.

The website can also contain a free text entry field, where the patient can be solicited to propose one or more additional terms of agreement, for consideration by the service provider. The service provider can then review the proposed terms, determine whether to accept them, and if accepting them can determine how to implement the custom terms. The service provider can also respond to proposed terms by providing an amended version of the proposed agreement for consideration by the patient as a possible term of agreement. One advantage of allowing the patient to propose customized terms is that if a significant number of subscribers want terms that the service provider did not originally contemplate, the service provider can discover what terms are desired, arrive at language that many subscribers find desirable, and add such terms to its proposed agreements.

Referring now to FIG. 1, in accordance with an embodiment of the invention, the information system 200 further comprises a data storage device 45. The data storage device 45, in accordance with an embodiment, comprises either or both of the storage medium 44 and the CD 50. The data processor 42 can be programmed to acquire a medical record in an storage format and then store it in the storage medium 44 in a form from which it can be reproduced in the storage format. Preferably, the medical record is also stored on the CD 50 and, as described above, basic information about the service provider (for example its name and website), the patient (for example his or her name and logon information), and instructions for use are optionally printed on an adhesive label or otherwise applied to the CD 50.

The Internet server 40 operating through the communication interface 210 of the information system 200 may further be programmed to induce the patient to update the medical record stored in the data storage device 45, and may further be programmed to induce the patient to provide other personal information or documents such as payment authorization information, health insurance provider information, a living will, investment portfolios, life insurance and credit arrangements to be stored in the data storage device 45.

Alternatively, in accordance with an embodiment of the present invention, the information system 200 is or comprises a home health file storage system, in which the communication interface 210 comprises the communicating devices and data processor of the computer 10 and the system software installed in it for the home health file storage system (not shown). The home health file storage system further comprises the data storage device of the computer 10, such as its hard drive, CD-burner, CD 50, etc. The computer 10 together with the system software installed in it are programmed to carry out all the functions of the Internet medical file storage system described above, i.e. the information system 200 comprising the Internet server 40, website 48, data processor 42 and data storage device 45. The home health file storage system may be either interactive with such an Internet medical file storage system or be independent.

In accordance with an embodiment of the invention, referring to FIG. 2, a hierarchical storage system 220 is used to store the medical record and other personal information or documents in the data storage device 45 (or the data storage device of the computer 10) of FIG. 1. The hierarchical storage system 220 comprises a general medical and personal information file 100 of the patient. This information file 100 comprises at least one file template 90 which comprises at least one file folder 80. The file folder 80 may comprise subfolders. The hierarchical storage system 220 provides hierarchical storage access, so access to a special file template is on a different basis than the one for entry to the general medical and personal information file 100 or other file templates.

For example, referring to FIG. 3, the information file 100 may include an emergency file template 92, an archive file template 94 and a medical file template 96. The emergency file template 92 is a special file template that is read-only to emergency medical personnel and contains medical information of the patient useful to emergency attendants. The emergency file template 96 can also contain payment authorization information, health insurance provider information, etc., so the emergency medical care personnel can be assured that the patient has the means to pay for the medical services required. The archive file template 94 can contains areas for providing information such as a living will, life insurance, etc., and the medical file template 96 can contain the complete medical file of the patient including payment authorization information, health insurance provider information, etc.

In this example, with the log-on information only, one can log on and have access to the emergency file template 901, while to log on and get access to the archive file template 94 and/or medical file template 96, one must answer a secret question in addition to provide the log-on information. In another embodiment of the invention, the emergency file template 92 is stored in a different CD 50 from the one storing the archive file template 94 and/or the medical file template 96. Access to the respective CD's can be independently controlled as by normally carrying the emergency CD with directions and access information printed on a label, and by normally having the archive CD at home, and by providing it with no legible password information so it cannot be read by others.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A method to obtain a medical record of a patient from a covered entity in a form allowing quick disclosure of said medical record to a third party without restriction by the Health Insurance Portability and Accountability Act of 1996, comprising:
inducing said patient to obtain possession of a medical record of said patient from a covered entity;
acquiring said medical record from said patient in a storage format; and
storing said medical record in a memory in a form from which it can be reproduced in said storage format.

2. The method of claim 1, further comprising inducing said patient to obtain possession of said medical record in a first format and inducing said patient to convert said medical record to said storage format, wherein said storage format is different from said first format.

3. The method of claim 1, further comprising obtaining the agreement of said patient to allow transmission of said medical record to a health care provider under defined conditions.

4. The method of claim 3, wherein said agreement is obtained before a defined condition arises.

5. The method of claim 1, wherein said memory is a portable medium.

6. The method of claim 5, wherein said portable medium is an optical disc.

7. The method of claim 1, further comprising retrieving said medical record stored in said memory remotely through a computer communications network.

8. The method of claim 1, further comprising inducing said patient to update said medical record stored in said memory.

9. The method of claim 1, further comprising inducing said patient to provide other information that is not a medical record, and storing said other information in said memory.

10. The method of claim 9, wherein said other information comprises information selected from the group consisting of a living will, investment portfolio, life insurance and a credit arrangement.

11. The method of claim 1, wherein said medical record is stored in a hierarchical storage system.

12. The method of claim 11, wherein said medical record is assigned to at least one file folder, said file folder containing medical records sharing at least one common attribute.

13. The method of claim 12, wherein said file folder is assigned to at least one file template, said file template containing file folders sharing at least one common attribute.

14. The method of claim 13, wherein a plurality of said file templates are stored in said storage system to form a general medical and personal information file of said patient.

15. The method of claim 12, wherein said file folder further comprises at least one sub-folder.

16. The method of claim 11, wherein said hierarchical storage system provides hierarchical storage access.

17. The method of claim 14, wherein access to a special file template is on a different basis than access to at least one other file template.

18. The method of claim 17, wherein said special file template is an emergency file template.

19. A method to induce conversion of a medical record of a patient from a covered entity to a form allowing quick disclosure of said medical record to a third party without restriction by the Health Insurance Portability and Accountability Act of 1996, comprising:
inducing said patient to obtain possession of a medical record of said patient from a covered entity;
inducing said patient to convert said medical record into a storage format; and
inducing said patient to store said medical record in a memory in said storage format.

20. The method of claim 19, further comprising providing said patient a system for converting said medical record into a storage format.

21. The method of claim 20, wherein said system is provided through a computer communications network.

22. The method of claim 20, wherein said system is provided in the form of software.

23. The method of claim 19, wherein said memory is a portable medium.

24. The method of claim 23, wherein said portable medium is an optical disc.

25. The method of claim 19, further comprising inducing said patient to update said medical record stored in said memory.

26. The method of claim 19, further comprising inducing said patient to obtain other information that is not a medical record, and to store said other information in said memory.

27. The method of claim 26, wherein said other information comprises information selected from the group consisting of a living will, investment portfolio, life insurance and a credit arrangement.

28. The method of claim 19, wherein said medical record is stored in a hierarchical storage system.

29. The method of claim 28, wherein said hierarchical storage system provides hierarchical storage access.

30. A medical and personal information system for obtaining and storing a medical record of a patient from a covered entity in a form allowing quick disclosure of said medical record to a third party without restriction by the Health Insurance Portability and Accountability Act of 1996, comprising:
a communication interface adapted for inducing said patient to obtain possession of a medical record of said patient from a covered entity; and
a data storage device comprising a memory adapted for storing said medical record in a form from which it can be reproduced in a storage format.

31. The system of claim 30, wherein said communication interface is adapted to induce said patient to obtain possession of said medical record in a first format and to induce said patient to convert said medical record to said storage format, wherein said storage format is different from said first format.

32. The system of claim 30, wherein said communication interface is adapted for acquiring said medical record from said patient in said storage format.

33. The system of claim 30, wherein said communication interface is adapted to obtain the agreement of said patient to allow transmission of said medical record to a health care provider under defined conditions.

34. The system of claim 33, wherein communication interface is adapted to obtain said agreement before a defined condition arises.

35. The system of claim 30, wherein said memory is a portable medium.

36. The system of claim 35, wherein said portable medium is an optical disc.

37. The system of claim 30, wherein said communication interface and said data storage device are operatively connected to enable said medical record stored in said memory to be retrieved remotely through a computer communications network.

38. The system of claim 30, wherein said memory is adapted to a hierarchical storage system.

39. The system of claim 38, wherein said hierarchical storage system comprises a general medical information file of said patient.

40. The system of claim 39, wherein said general medical information file comprises a file template.

41. The system of claim 40, wherein said file template comprises a file folder.

42. The system of claim 41, wherein said file folder comprises a sub-folder.

43. The system of claim 38, wherein said data storage device provides hierarchical storage access.

44. The system of claim 40, wherein said general medical information file comprising a special file template accessed on a different basis from said general medical information file.

45. The system of claim 44, wherein said special file template is an emergency file template.

46. The system of claim 44, wherein said special file template is stored in a first memory and said general medical information file is stored in a second memory wherein said first and second memories are different optical discs.

47. The system of claim 30, wherein said memory is adapted for storing other information of the patient that is not a medical record.

48. The system of claim 47, wherein said other information comprises information selected from the group consisting of a living will, an investment portfolio record, a life insurance record and a credit arrangement.

49. The system of claim 30, wherein said communication interface is adapted to induce said patient to update said medical record stored in said memory.
